(19) United States
(12) Patent Application Publication
(10) Pub. No.: US 2019/0390955 A1
(43) Pub. Date: Dec. 26, 2019

(54) Method of vertical displacement measurement of building structural elements

(71) Applicant: WiSeNe Sp. z o.o., Warsaw (PL)

(72) Inventors: Zbigniew Pioro, Julianow (PL); Marcin Osiniak, Warsaw (PL); Edward Antoszkiewicz, Julianow (PL); Stanislaw Wierzbicki, Warsaw (PL)

(73) Assignee: WiSeNe Sp. z o.o.

(21) Appl. No.: 16/435,894

(22) Filed: Jun. 10, 2019

(30) Foreign Application Priority Data
Jun. 22, 2018 (PL) P.426037

(51) Int. Cl. G01B 21/32; G01C 5/00

(52) U.S. Cl. CPC G01B 21/32; G01C 5/00

(57) ABSTRACT

A method of vertical displacement measurement of structural elements of a building, includes the placing of a measuring target for a laser beam, with the target inclined at an angle β from horizontal, placing a laser rangefinder for measuring an inclination angle α of the laser beam, emitting the laser beam at the angle α to hit the target and reflect back, measuring the distance from the laser rangefinder to the target, wherein the inclination angle β of the target is saved, followed by measuring at two time points t₁ and t₂ the distances from the rangefinder to the target, equal to b₁ and b₂, respectively, and at the same time points measuring the angle of inclination, α₁ and α₂, respectively, of the laser beam, followed by calculating the value of vertical displacement vd of the target relative to the rangefinder, which occurred between time points t₂ and t₁.

### BACKGROUND

Vertical displacements of building structures are caused by various factors, e.g. precipitation, temperature changes or permanent effects of the impact of wind.

The individual elements of roof structure bend due to load, causes a vertical displacement of the individual points of the structural elements. According to the experts, the measurements of such a displacements are a very good and credible way to evaluate the degree of load carrying capacity exhaustion, and therefore the degree of risk of the users safety.

It is best to measure the magnitude of vertical displacement in a place where it has its maximum value, typically at the centre of structural element, wherein the measurement should be performed to a fixed reference point. The maximum permitted value of vertical displacement vdₚₑᵣ is easily determined for building structures using standard design tools, and it is an integral part of a construction design. In order to evaluate the load carrying capacity exhaustion, the vertical displacement of structural elements under the given load is compared to permitted values.

The basic methods of vertical displacement measurement uses the laser devices. In general, there are two methods of the vertical displacement measurements of structural elements, differing in the position of the laser beam relative to the vertical: a vertical measurement and a measurement at an angle (in particular—a horizontal measurement). The vertical measurement involves measuring the distance between a measurement point located on the monitored structural element and a reference point—a stable substrate located vertically under the measurement point, while the measurement at an angle (in particular—the horizontal measurement) is based on directing a laser beam at an angle from the vertical, in particular at an angle 90° from the vertical, that is horizontally. In accordance with the measurement method, a measuring device comprising a laser rangefinder is attached so that the laser beam is directed vertically or at an angle from the vertical (in particular—horizontally). The simplest example of measurements performed at an angle from the substrate are measurements performed horizontally.

From Polish patent application P.393402 and U.S. Pat. No. 8,788,240B2 there is a known technology using laser rangefinders, related to a method for monitoring the vertical displacement component and the vertical bending component of building structural elements. The described solution constitutes an example of vertical measurements, i.e. the performed measurements involve distance to fixed elements located vertically under measurement points, such as a floor.

Polish application description P.381578 presents a simple method for monitoring a roof structure using horizontal measurement, based on directing a laser beam below roof structure beams. By excessive bending of at least one beam equipped with a special shutter interrupts the light ray and the audible and visual alarms are activated.

From international patent application WO2006011386A1 (see U.S. Pat. No. 7,535,554 B2) there is a known method for measuring the vertical displacement of bridge arches. This method comprises placing a measuring target with a scattering element for the laser beam in the measurement point of a measured object, such that the scattering element is inclined at an angle relative to the displacement measurement direction. The laser rangefinder is put in a place which is shifted in a direction perpendicular to the displacement measurement direction relative to the position of the measured object. The laser beam emitted from the laser rangefinder hits the scattering element, and radiation reflected from this element returns to the laser rangefinder. Subsequently, the measurement of a change of the distance from the laser rangefinder to the scattering element for the laser beam is performed, and the displacement of an object in the displacement measurement direction is measured by using the relationship between the detected distance change and the displacement of the measured object in the displacement measurement direction. The laser rangefinder is placed on the supports of a bridge, which are usually very stable; therefore, there is no risk of changing its spatial position. The method does not predict, and therefore does not take into account the influence of possible displacement of bridge supports, and therefore the displacement of the laser rangefinder, on the measurement results.

The method for measuring the vertical displacements of building roof structures presented in Polish application P.419127 (see WO 2018/069897 A1) is based on a similar principle. The described method also does not take into account the possibility of the occurrence of measurement errors related to the displacement of the measuring device, in particular a change of the inclination of the rangefinder optical axis.

From this international patent application WO2018/069897A1 there is also a known measurement system for measurement of structural element displacement, provided with a measuring device having a central processing unit, a memory connected to a central unit for storing the measurement results, a communication unit for transmitting the measurement results, a display and a rangefinder with a measurement axis directed towards the measurement object, wherein the measuring apparatus and the measurement object are adjusted to being attached opposite each other, one of them to the element being displaced, and the other one to a reference element of the structure. The system is characterized in that the laser rangefinder has a substantially horizontal measurement axis, the measuring device with the rangefinder is provided with a self-levelling system, adjusted to attachment to structural elements, and the measurement object has a conical surface with a substantially vertical axis of rotation and a cone angle ranging from 80° to 100°, and it has a self-righting system. The measuring device can be provided with an inclinometer detecting deviation of the laser beam from the horizontal by more than 2° (claim 5). Detection of excessive inclination (more than 2°) of the laser beam triggers an alert—this is the only use of the measurement results performed with the built-in inclinometer. In particular, the measurement results of the inclination angle, both initial and its changes at any time, e.g. affected by a change of the load of the structure, are not considered anywhere.

### SUMMARY

An object of the invention is a method of vertical displacement measurement of building structural elements. This method can be used to monitor the vertical displacements of building structures are caused by various factors, e.g. precipitation, temperature changes or permanent effects of the impact of wind. In particular, the method can be used to monitor roof structures under variable load.

The purpose of the invention thus includes the development of a reliable method for monitoring the vertical displacement of the building structural elements, in particular the roof of a building, using laser measurement at an angle (in particular—horizontal) of the distance, resistant to the movements and/or rotations of the structure, that allows the achievement of a result insensitive to changes in the inclination of the laser beam emitted from the measuring device. As shown below, a change of the inclination of the laser beam, equal to much less than 2°, causes very large measurement errors, that completely disqualify the possibility to implement reliable monitoring of buildings using such measurements. The invention is meant to provide elimination of measurement errors which are a consequence of a change of the inclination of the laser beam emitted from the measuring device.

In particular, the object of the invention may be carried out by a method for measuring the vertical displacement of the building structural elements, comprising the placement of a measuring target including a scattering element for the laser beam, so that the scattering element is inclined at the angle β from the horizontal, and the placement of a measuring device comprising a laser rangefinder and an inclinometer measuring the angle α of the laser beam inclination from the horizontal, in a place which is shifted horizontally and optionally vertically relative to the measuring target, and emitting the laser beam from the laser rangefinder at the angle α from the horizontal, in such a way that the beam hits the scattering element of the measuring target, as well as the return of the beam reflected from the scattering element to the laser rangefinder in a direction parallel to the direction of the emitted laser beam and performing the measurement of distance from the laser rangefinder to the scattering element, characterized by measuring and memorizing the inclination angle β of the scattering element, followed by measurement at two time points t₁ and t₂ the distance from the measuring device to the scattering element of the measuring target, equal to b₁ and b₂, respectively, and at the same time points the inclination angle, α₁ and α₂, respectively, of the laser beam from the horizontal is measured, followed by calculating the value of vertical displacement vd of the measuring target relative to the measuring device, which occurred between time points t₂ and t₁.

Preferably, the measuring target with a scattering element is mounted in a measurement point of the monitored structural element, and the measuring device is mounted in the reference point.

Preferably, the measuring device is mounted in the measurement point of the monitored structural element, and the measuring target with a scattering element is mounted in the reference point.

Preferably, the vertical displacement vd of the measuring target relative to the measuring device, which occurred between time points t₂ and t₁, is calculated by the formula:

$$vd = ( {b}_{1} \cdot ( cos {α}_{1} + \frac{sin {α}_{1}}{tan β} ) - {b}_{2} \cdot ( cos {α}_{2} + \frac{sin {α}_{2}}{tan β} ) ) \cdot tan β \qquad ( 1 )$$

Preferably, for a value of the inclination angle β from the horizontal of the scattering element of the measuring target equal to 45°, the value of vertical displacement vd is calculated by the formula simplified to the following form:

vd=b₁·(cos α₁+sin α₁)−b₂·(cos α₂+sin α₂) (2)

Preferably, for a value of the inclination angle β from the horizontal of the scattering element of the measuring target equal to 45°, and an inclination angle α₁=0 and stability of the inclination angle from the horizontal a over time, that is for α₂=0, the value of vertical displacement vd is calculated by the formula simplified to the following form:

vd=b₁−b₂ (3)

### BRIEF DESCRIPTION OF THE DRAWINGS

The method according to the invention is explained for example in the figures, wherein

FIG. 1 presents a method for performing an measurement at an angle, for a single-span framework under the conditions of variable inclination of the laser beam emitted from the measuring device,

FIG. 2 depicts a situation A and a situation B wherein the measuring target depicted in situation A has been placed in measurement point P of the monitored element, with the measuring device in reference point R, while the measuring device depicted in situation B has been placed in the same measurement point P, and the measuring target has been placed in reference point R;

FIG. 3 shows the principle of laser measurement at an angle of the vertical displacement using the method according to the invention, and

FIG. 4 shows the method for measuring vertical displacement according to the invention, for an experimental system under variable load conditions.

### DETAILED DESCRIPTION

In the simplest case, the measurement at an angle is simplified to a horizontal measurement. Then the measuring device comprising the laser rangefinder measures horizontally a change of the distance from the plane of the scattering element of the measuring target. In a case when the laser beam is positioned horizontally and the plane of the scattering element of the measuring target is inclined at an angle of 45° from the horizontal, the change of the reading of the rangefinder directly equals to plus-minus the vertical displacement vd of the structural element in measurement point P (the place of attachment of the laser rangefinder or the measuring target). However, such a situation takes place only when the inclination from the horizontal of the laser beam emitted from the measuring device is stable and it does not depend on the load of the frame.

However, bending of a structural element, e.g. a girder or a rafter, under load or other factors, can cause deformation of structural elements, to which the measuring device is attached, which affects both the inclination of the laser beam from the horizontal and the distance to the measuring target (for example, mounted in the ridge) measured by the rangefinder. In case of the occurrence of such deviations from the “perfectly still” position of the laser beam defined above, and the predetermined inclination of the scattering element (a horizontal laser beam and inclination of the target from the horizontal equal to 45°), it is necessary to perform additional trigonometric calculations, that is a trigonometric correction of the measurement result.

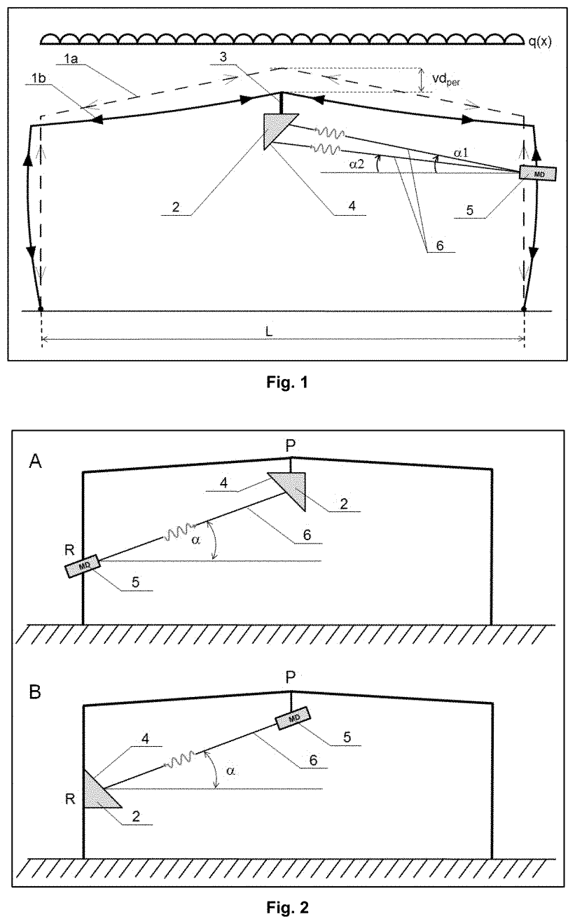

Under realistic conditions, the frame or other structural elements (in general, the structural system), whose bending is to be measured, undergo deformations and all elements of this system can rotate under a variable load, which is shown in FIG. 1, where the original status of a single-span framework system 1a at the time point t₁ is marked by a dashed line, and the deformed state 1b at the time point t₂ by a solid line. In the situation presented in FIG. 1, a measuring target 2 comprising a scattering element 4 for the laser beam 6 has been placed in the ridge by means of a holder 3, and the measuring device 5 with a laser rangefinder emitting the laser beam 6 has been placed on the frame column. The upper part of FIG. 1 shows a uniformly distributed load q(x).

As shown in FIG. 1, if the measuring device with the laser rangefinder is rigidly mounted to the frame column (to the structural element), then after the load the column will rotate (its inclination will change) by the angle (α₂−α₁). Inclination of the laser beam from the horizontal will change by the same angle. Assuming that the length of the rafter is equal to 20 m, the inclination of the scattering element of the measuring target is 45°, and before loading the frame (at the time point t₁) the laser beam was directed horizontally (i.e. α₁=0), and after the load, due to the bending of the frame elements, the laser beam has rotated and it is inclined at an angle of 0.1° from the horizontal (i.e. α₂=0.1°), then the change of the measured distance caused only by a change of the inclination angle of the laser beam will equal to, based on formula (2), approximately −1.75 cm.

Assuming that the abovementioned rotation by 0.1° is caused by displacement of the frame in the ridge equal to 2 cm (20 mm), then in such a case the measurement result for vertical displacement in the ridge will equal to 0.25 cm instead of 2 cm.

Therefore, the measurement result in this case is 8 times lower than the real vertical displacement, which results in a relative measurement error of 90%. Therefore, this measurement is absolutely unacceptable. A value of 10% can be assumed to be an acceptable measurement error in this type of application; therefore, measurement methods that do not take into account the risk of errors described are not suitable for reliable monitoring of building structures.

The measurement at an angle of the vertical displacement in a measurement point according to the invention takes into account the variable inclination angle of the laser beam from the horizontal α, which allows to eliminate the effect of changes of this angle on the measurement result of the vertical displacement vd. Additionally, the method according to the invention allows taking into account any inclination angle β from the horizontal of the scattering element for the laser beam of the measuring target, wherein this angle must be constant during the performance of measurements (must be constant between time points t₂ and t₁, for which the vertical displacement is calculated).

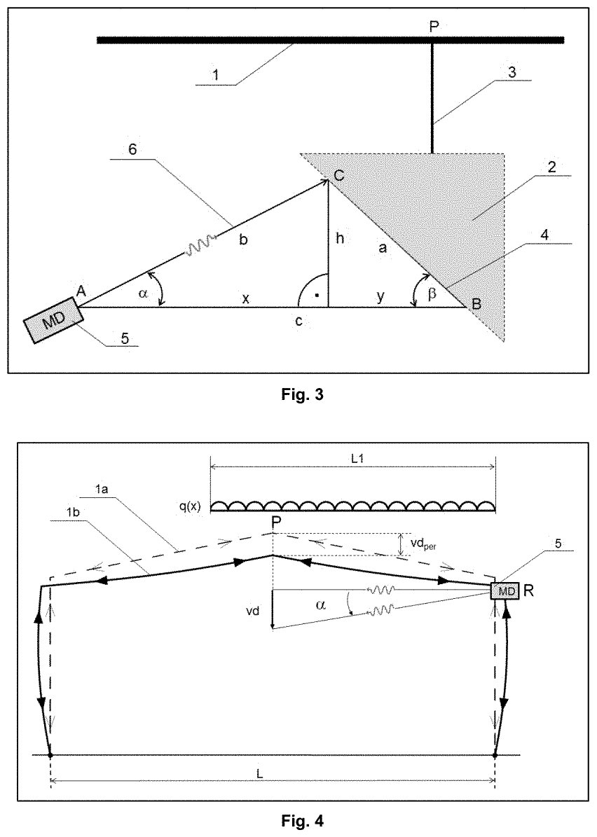

The situations A and B depicted in FIG. 2 present two possible variants of the arrangement of the measuring device relative to the measuring target, which are exemplary variants of the method according to the invention. For the purpose of carrying out the method according to the invention, the following dependences are derived from the indications depicted in FIG. 3 for the variant depicted in the situation A of FIG. 2, however, these calculations are also useful for the second embodiment of setting up the measuring device relative to the measuring target, depicted in the situation B of FIG. 2.

FIG. 3 presents a geometrical structure having sides or edge segments a, b, con the basis of which the trigonometric formulas were obtained for the method according to the invention, using the results of the performed measurements for calculating the vertical displacement vd of the monitored measurement point P of a structural element relative to the reference point R.

FIG. 3 introduces the following references:
the angle α stands for the inclination angle from the horizontal edge c of the laser beam emitted from the rangefinder of the measuring device MD,
the measuring device is placed in vertex A,
the edge a is a segment lying on the surface of the scattering element for the laser beam of the measuring target, to which the measurement is performed,
the edge b represents the distance measured by the measuring device (and more precisely, the laser rangefinder contained therein),
the edge c represents the distance which would be measured by the measuring device if the laser beam were positioned horizontally,
the angle β stands for the inclination angle of the surface of the scattering element for the laser beam of the measuring target.

The height h of the triangle perpendicular to the edge c divides this edge into two segments with the lengths x and y. These lengths fulfil the following formula:

x+y=c (4)

The following formulas can be defined for the angles α and β:

$$\begin{matrix}cos α = \frac{x}{b} & ( 5 ) \\ cos β = \frac{y}{a} & ( 6 )\end{matrix}$$

By entering x determined from equation (5) and y determined from equation (6) into equation (4), the following formula is produced:

b·cos α+a·cos β=c (7)

The height h divides the triangle abc into two rectangular triangles. Based on the Pythagorean theorem, the following formula is fulfilled for these triangles:

b²−x²=a²−y² (8)

By entering x determined from equation (5) and y determined from equation (6) into equation (8), the following formula is produced:

b²−b² cos²α=a²−a² cos²β (9)

By rearranging equation (9) and extracting roots from both sides, as well as assuming that a>0 and b>0, the following formula is achieved:

b\sqrt{1−cos²α}=a\sqrt{1−cos²β} (10)

By using the “Pythagorean trigonometric identity” and further rearranging the equation (10), the following formula is achieved:

b·sin α=a·sin β (11)

The formulas (7) and (11) form a system of two linear equations with the variables a and b. By determining a from equation (11) and putting it into equation (7), the following formula is achieved:

$$b \cdot ( cos α + \frac{sin α}{sin β} \cdot cos β ) = c \qquad ( 12 )$$

By further rearranging the equation (12) the following formula is achieved:

$$c = b \cdot ( cos α + \frac{sin α}{tan β} ) \qquad ( 13 )$$

With two values of distance b, originating from two different measurements, one can determine the corresponding displacement in the horizontal axis Δc, which then can be converted into vertical displacement vd based on the following formula:

vd=Δc·tan β (14)

In general, to determine the current value of the vertical displacement vd of the monitored point P relative to the reference point R (in FIG. 3 identical to point A), it is therefore necessary:
the initial measurement result of distance b₁ measured by the measuring device,
the initial measurement result of the inclination angle α₁ of the laser beam during the performance of distance measurement b₁,
the current distance measurement result b₂,
the current measurement result of the inclination angle α₂ of the laser beam during the performance of distance measurement b₂.

Based on these four values, the vertical displacement vd is determined by the following formula:

$$vd = ( {b}_{1} \cdot ( cos {α}_{1} + \frac{sin {α}_{1}}{tan β} ) - {b}_{2} \cdot ( cos {α}_{2} + \frac{sin {α}_{2}}{tan β} ) ) \cdot tan β \qquad ( 1 )$$

The method according to the invention, as it is insensitive to the value of the angle α, makes it possible to accurately measure the vertical displacement by laser measurement of the distance at an angle, in practice in the range of 0-45°

This enables mounting the measuring target close to the monitored structural element, and the measuring device with a laser rangefinder and inclinometer directly to the structure, which can become deformed.

The method according to the invention comprising the above calculations has been used in practice for an experimental structural arrangement presented in FIG. 4, for which a numerical simulation of the measurements discussed above was performed. FIG. 4 presents the points: of measurement P and of reference R, and a downward arrow marks the measured vertical displacement vd. FIG. 4 does not show this; however, the monitored structure comprised a fixed measuring target in measurement point P, with a scattering element for the laser beam. It was assumed that the angle β=45°, and formula (2) was used. Table 1 presents the results of a horizontal measurement (α₁=0), performed using the method according to the invention.

TABLE 1
List of the values of vertical displacement vdᵣ of the measurement point
P determined from formula (1), the angle of rotation of the column in
corner α₂, the measured value of vertical displacement vdₘ of the
measurement point P without taking into account the change of the
inclination angle of the laser beam resulting from load (bending of the
column) and the measurement errors of vertical displacement of the
measurement point P - absolute Δvd and relative δ_{vd} -
for the frame shown in FIG. 4 (for L = 29.5 m), for various load
patterns - from uniformly distributed over the whole width of the roof
(L1 = L) to located at 1/10 of the length (L1 = L/10) of the right half.

| | | b₂ | α₂ | vdᵣ* | vdₘ** | Δvd*** | |
|---|---|---|---|---|---|---|---|
| No. | L1/L | [mm] | [°] | [mm] | [mm] | [mm] | δ_{vd}**** |
| a | b | c | d | e | f | g | h |
| 1 | 1.00 | 14720.9 | −0.120 | 60.0 | 29.1 | 30.9 | 51% |
| 2 | 0.90 | 14724.3 | −0.131 | 59.4 | 25.7 | 33.7 | 57% |
| 3 | 0.80 | 14733.6 | −0.157 | 56.8 | 16.4 | 40.4 | 71% |
| 4 | 0.70 | 14746.5 | −0.184 | 50.9 | 3.5 | 47.4 | 93% |
| 5 | 0.60 | 14760.0 | −0.200 | 41.6 | −10.0 | 51.6 | 124% |
| 6 | 0.50 | 14770.6 | −0.196 | 30.0 | −20.6 | 50.6 | 169% |
| 7 | 0.40 | 14775.5 | −0.170 | 18.4 | −25.5 | 44.0 | 239% |
| 8 | 0.30 | 14772.9 | −0.124 | 9.1 | −22.9 | 31.2 | 343% |
| 9 | 0.20 | 14764.3 | −0.068 | 3.2 | −14.3 | 17.5 | 547% |
| 10 | 0.10 | 14754.6 | −0.020 | 0.6 | −4.6 | 5.2 | 866% |

*vdᵣ = b₁(sin(α₁) + cos(α₁)) − b₂(sin(α₂) + cos(α₂)) = L/2 − b₂(sin(α₂) + cos(α₂))
**vdₘ = b₁ − b₂ = L/2 − b₂
***Δvd = vdᵣ − vdₘ
****δ_{vd} = Δvd/vdᵣ

Implementation of the invention in practice proved the importance of a correction of measurement results taking into account a change of the inclination of the laser beam (angle α) during the monitoring of a building structure. Results of the vertical displacement measurement without correction related to a non-zero value of the rotation angle of the column in the corner—column fin Table 1—are subject to very large errors of several dozen to several hundred percent—column h in Table 1. Therefore, they are completely unacceptable. The used measurement method is insensitive to a change of this angle (column e in Table 1), which generally increases safety and reliability of the measurement system executing the method according to the invention. A change of the inclination angle of the laser beam emitted from the measuring device can occur due to various circumstances, e.g. roof load, temperature changes, during renovations/structural changes of buildings; therefore, the development of a method which takes into account the change of the angle α, i.e. the inclination of the laser beam during measurements, allows eliminating errors related, among other things, to such factors.

By allowing the execution of the measurement at an angle (with a non-zero value of the angle α₁), the developed method provides additional flexibility and possibility to reduce various types of measurement errors. In particular, by mounting the measuring target and/or the measuring device close to the monitored element, it is possible to reduce measurement errors related to long mounting elements, particularly large for an asymmetrical load of structure. Also, by directing the laser beam possibly parallel to the monitored structural element, it is possible to reduce measurement errors resulting from a change of the distance between the measuring device and the measuring target caused by load of structure.

1. A method of vertical displacement measurement of building structural elements comprising:
placing a measuring target with a scattering element for a laser beam, so that the scattering element is inclined at an angle β from horizontal, and
placing a measuring device, comprising a laser rangefinder and an inclinometer measuring an inclination angle α of the laser beam from the horizontal, in a place that is shifted horizontally and optionally vertically to the measuring target, and
emitting the laser beam from the laser rangefinder at the inclination angle α relative to the horizontal in such a manner that the beam hits the scattering element of the measuring target, and
receiving a return of the beam reflected from the scattering element to the laser rangefinder in a direction parallel to the direction of the emitted laser beam and measuring the distance from the laser rangefinder to the scattering element, wherein
the inclination angle β of the scattering element (4) is measured and memorized, followed by
measuring at two time points t₁ and t₂ distance from the measuring device (5) to the scattering element (4) of the measuring target (2), equal to b₁ and b₂, respectively, and at the same time points measuring the angle of inclination, α₁ and α₂, respectively, of the laser beam (6) from the horizontal, upon which
the value of vertical displacement vd of the measuring target (2) relative to the measuring device (5) which occurred between time points t₂ and t₁ is calculated using the measured values of b₁, b₂, α₉, α₂ and the memorized value of β.

2. The method according to claim 1 wherein the measuring target (2) with a scattering element (4) is mounted in a measurement point (P) of the monitored structural element, and the measuring device (5) is mounted in the reference point (R).

3. The method according to claim 1, wherein the measuring device (5) is mounted in the measurement point (P) of the monitored structural element, and the measuring target (2) with a scattering element (4) is mounted in the reference point (R).

4. The method according to claim 1, wherein the value of vertical displacement vd of the measuring target (2) relative to the measuring device (5), which has occurred between time points t₂ and t₁, is calculated by the formula:
$$vd = ( {b}_{1} \cdot ( cos {α}_{1} + \frac{sin {α}_{1}}{tan β} ) - {b}_{2} \cdot ( cos {α}_{2} + \frac{sin {α}_{2}}{tan β} ) ) \cdot tan β .$$

5. The method according to claim 4, wherein for the value of the inclination angle β from the horizontal of the scattering element (4) of the measuring target (2) equal to 45°, the value of vertical displacement vd of the measuring target (2) relative to the measuring device (5), which occurred between time points t₂ and t₁, is calculated by the formula simplified to the following form:
vd=b₁·(cos α₁+sin α₁)−b₂·(cos α₂+sin α₂).

6. The method according to claim 4, wherein for the value of the inclination angle β from the horizontal of the scattering element (4) of the measuring target (2) equal to 45°, and the inclination angle from the horizontal α₁=0 and stability of the inclination angle from the horizontal a over time, that is α₂=0, the value of vertical displacement vd of the measuring target (2) relative to the measuring device (5), which occurred between time points t₂ and t₁, is calculated by the formula simplified to the following form:
vd=b₁−b₂.
